(19) United States
(12) Patent Application Publication
(10) Pub. No.: US 2004/0209063 A1
(43) Pub. Date: Oct. 21, 2004

(54) Microporous sheets including a colored base coating and a clear coating

(76) Inventors: Kevin P. Gallagher, Gibsonia, PA (US); Calum H. Munro, Wexford, PA (US); Brian K. Rearick, Allison Park, PA (US); Victoria A. Trettel, Freeport, PA (US)

Correspondence Address: PPG INDUSTRIES, INC., Intellectual Property Department, One PPG Place, Pittsburgh, PA, 15272, US

(21) Appl. No.: 10/844,281

(22) Filed: May 12, 2004

Related U.S. Application Data
(63) Continuation-in-part of application No. 10/395,566, filed on Mar. 24, 2003.

(51) Int. Cl. B32B 3/26; B32B 3/00; B32B 9/00; B32B 5/20; B01D 39/00; B01D 39/14; B01D 71/26

(52) U.S. Cl. 428/304.4; 428/318.4; 428/318.8

(57) ABSTRACT

Microporous sheets coated with a colored base coating and a clear coating are disclosed. The coated microporous sheets are durable and possess desirable visual characteristics such as high gloss and distinctiveness of image.

### CROSS REFERENCE TO RELATED APPLICATION

This application is a continuation-in-part of U.S. application Ser. No. 10/395,566 filed Mar. 24, 2003, which is incorporated herein by reference.

### FIELD OF THE INVENTION

The present invention relates to coated microporous sheets, and more particularly relates to microporous sheets having one or more decorative and/or protective coatings thereon.

### BACKGROUND INFORMATION

Microporous sheets comprise a matrix of thermoplastic organic polymer with interconnecting pores and optional filler particles. An example of a microporous sheet comprises polyethylene and silica filler particles sold under the designation Teslin® by PPG Industries, Inc. Microporous sheets are useful in many applications such as cards, tags, labels, menus, in-mold graphics, commercial printing and specialty printing.

U.S. application Ser. No. 10/395,566 relates to coated microporous sheets that have high durability and can be used for in-mold applications. However, there is a need for ductile coated microporous sheets that possess tailored visual characteristics such as high gloss and distinctiveness of image.

### SUMMARY OF THE INVENTION

The present invention provides composite coatings for microporous sheets. A colored base coating is applied on the microporous sheet, and a clear coating is applied over the colored base coating. The coated microporous sheets are durable and are capable of withstanding substantial elongation before breaking. The coated sheets also possess god mar resistance and scratch resistance. The coated sheets further possess desirable visual characteristics, such as high gloss and high distinctiveness of image (DOI).

### BRIEF DESCRIPTION OF THE DRAWINGS

FIG. 1 is a partially schematic side view of a microporous sheet coated with a colored base coating and a clear coating in accordance with an embodiment of the present invention.

FIG. 2 is a partially schematic side view of a microporous sheet coated with a colored base coating, intermediate layer and clear coating in accordance with another embodiment of the present invention.

FIG. 3 illustrates a technique for applying a clear coating on a microporous sheet having a base coating in accordance with an embodiment of the present invention.

FIG. 4 is a partially schematic side view of a laminated article including a substrate covered by a microporous sheet having a colored base coating and a clear coating in accordance with an embodiment of the present invention.

### DETAILED DESCRIPTION

The present invention provides a colored base coating and a clear coating for microporous sheets. The coatings are ductile and provide desirable visual characteristics such as visual effects, high gloss and/or distinctiveness of image (DOI). The base coating forms a surface layer or film on at least a portion of a microporous sheet. A portion of the base coating may penetrate at least partially into the pores of the microporous sheet. The clear coating covers at least a portion of the colored base coating and is selected to provide desired visual characteristics such as high gloss and/or DOI.

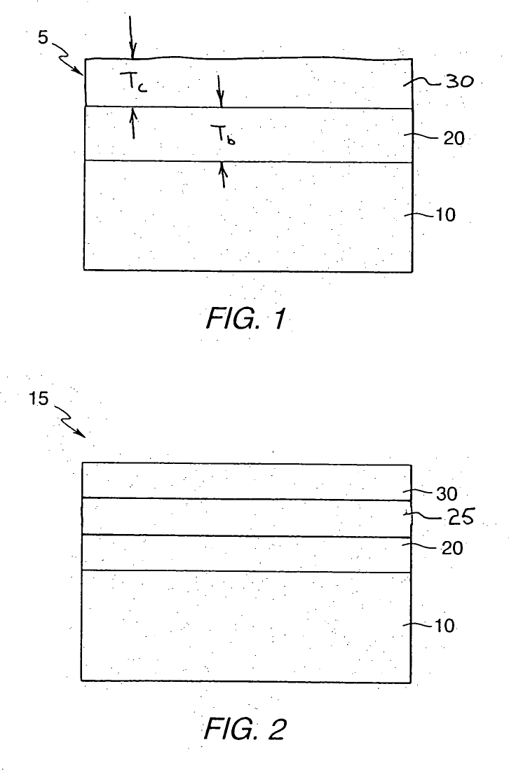

FIG. 1 illustrates a coated microporous sheet 5 comprising a microporous sheet 10 coated with a colored base coating 20 and a clear coating 30 in accordance with an embodiment of the present invention. As used herein, the term “colored base coating” includes any coating applied on a microporous sheet that gives the sheet a different visual appearance than the underlying microporous sheet. The colored base coating 20 may comprise any suitable composition, such as water based acrylics, polymers, polyurethanes, polyesters, vinyls, epoxies, polyamids and polyethers, as more fully described below. In one embodiment, the colored base coating 20 has a dry film thickness T_{b} that is typically greater than 2 or 3 microns. For example, the dry film thickness T_{b} measured from the surface of the microporous sheet of the colored base coating 20 may be from 5 to 50 microns or more. A typical thickness T_{b} is 10 to 25 microns.

Although the colored base coating 20 is shown as a continuous layer or film on the surface of the sheet 10 in FIG. 1, at least a portion of the colored base coating 20 may penetrate into the microporous sheet 10. In one embodiment, the colored base coating 20 does not completely fill the pores of the microporous sheet 10, such that the interconnected pore structure is maintained throughout at least a portion of the sheet. The colored base coating 20 may be applied directly to the microporous sheet 10. Although not required for many applications, a primer, sealer, or other undercoat (not shown) may be used between the colored base coating 20 and the microporous sheet 10.

The clear coating 30 provides desired visual characteristics, such has high gloss and/or distinctiveness of image. Gloss values and distinctiveness of image values may be tailored. For example, the clear coating 30 may provide a 20° gloss of at least 50, typically 60 or 70 or higher. For example, the 20° gloss may be at least 80 or 85. The coated microporous sheet may have a DOI as measured with a C-Box of at least 20 or 30, for example 40 or 50. As a particular example, the DOI may be at least 70 or 75. Use of a C-Box will be known to those skilled in the art and is further described in the Examples. In one embodiment, the coatings may have a Class A finish with high 20° gloss and DOI values. The clear coating may be UV or heat curable. The clear coating 30 has a dry film thickness T_{c} that is typically greater than 2 or 3 microns, for example, from 10 to 50 microns.

The clear coating 30 may compromise polyurethanes, acrylics, polyethers, polyesters, polyamides, thermoplastic polyolefins, poly(halo-substituted olefins), polyureas, poly(vinyl halides), poly (vinylidene halides), polystyrenes, poly(vinyl esters), polycarbonates, polysulfides, polyimides, polysilanes, polysiloxanes, polycaprolactones, polyacrylates and/or polymethacrylates. Hybrid classes, for example, thermoplastic poly(urethane-ureas), poly(ester-amides), poly(silane-siloxanes) and poly(ether-esters) may be used.

In accordance with an embodiment of the present invention, the clear coating 30 comprises a cured thermoset coating, which may be cured by ultraviolet radiation or heating. The clear coating 30 may comprise a polyurethane. In one embodiment, the clear coating 30 comprises a UV curable urethane/acrylate. The urethane/acrylate may be formed in any manner known in the art, such as by reacting a polyol, a polyisocyanate and a hydroxyacrylate. In this embodiment, typical components of the urethane/acrylate comprise from 10 to 95 weight percent polyol, from 5 to 60 weight percent polyisocyanate, and from 3 to 50 weight percent hydroxyacrylate. The polyol may comprise a polyester polyol. In addition to a UV curable urethane/acrylate, the clear coating 30 may further comprise ultraviolet light absorbers, hindered amine light stabilizers and/or plasticizers in total amounts up to 80 weight percent of the coating.

In accordance with an embodiment of the present invention, the clear coating 30 composition to be applied on the colored base coating 20 may comprise from about 10 to about 90 weight percent of a polyurethane/acrylate resin based on the total weight of the clear coating composition. The clear coating composition may comprise a suitable solvent, such as organic solvents or water. The clear coating composition may further comprise optional additives such as ultraviolet light absorbers, hindered amine light stabilizers, plasticizers and the like. In one embodiment, the clear coating 30 composition to be applied to the colored base coating 20 comprises less than 5 weight percent organic solvent based on the total weight of the clear coating composition. The clear coating composition may comprise from about 20 to about 80 weight percent water based on the total weight of the clear coating composition. In one embodiment, substantially all of the clear coating composition forms a solid material after it is cured.

The clear coating 30 may be applied on the colored base coating 20 by any suitable technique. For example, the clear coating 30 may be applied directly on the colored base coating 20 in liquid form by spraying, painting, rolling, dipping or the like. Alternatively, the clear coating composition may first be applied on a release sheet, followed by application of the clear coating and release sheet onto the colored base coating, as more fully described below.

The colored base coating 20 may comprise any suitable material such as acrylics, polymers, polyurethanes, polyesters, vinyls, epoxies, polyamids and polyethers. In one embodiment, the colored base coating 20 composition is substantially solvent free. The term “substantially solvent-free” as used herein when referring to the colored base coating composition means that the base coating composition contains less than about 15 or 20 weight percent organic solvents, preferably less than 5 or 10 weight percent, with weight percent being based on the total weight of the coating composition to be applied to the microporous sheet. For example, the base coating composition may contain from zero to 2 or 3 weight percent organic solvents.

The term “water-based” as used herein to describe the colored base coating 20 composition means base coating compositions in which the carrier fluid of the composition is predominantly water on a weight percent basis, i.e., more than 50 weight percent of the carrier comprises water. The remainder of the carrier comprises less than 50 weight percent organic solvent, typically less than 25 weight percent, such as less than 15 weight percent. Based on the total weight of the base coating composition (including the carrier and solids), the water may comprise from about 20 to about 80 weight percent, typically from about 30 to about 70 weight percent, of the total base coating composition.

The substantially solvent-free, water-based coating compositions used for the colored base coatings 20 in accordance with an embodiment of the present invention comprise resins such as polyurethanes, acrylics, polyesters, polyethers, polycarbonates, polyamides, epoxies, vinyls and the like. Any resin that forms a suitable film and is compatible with water-based compositions can be used in the base coating composition in accordance with the present invention, absent compatibility problems. Examples of polymers useful in forming the resin may include hydroxyl or carboxylic acid-containing acrylic copolymers, hydroxyl or carboxylic acid-containing polyester polymers, oligomers and isocyanate or hydroxyl-containing polyurethane polymers, and amine or isocyanate-containing polyureas. Some resins that may be suitable for use in the colored base coating compositions are described in U.S. Pat. No.5,939,491, which is incorporated by reference herein.

The film-forming resin is generally present in the colored base coating composition in an amount greater than about 20 weight percent, such as greater than about 40 weight percent, and less than 90 weight percent, with weight percent being based on the total solid weight of the cured colored base coating 20. For example, the weight percent of resin can be between 20 and 80 weight percent.

Suitable polyurethane resins for use in the colored base coating include a polyisocyanate, an active hydrogen-containing material (polyols, polyethers, polyesters, polycarbonates, polyamides, polyurethanes, polyureas, polyamines and mixtures thereof), an acid functional material having a functional group reactive with isocyanate and optionally a polyamine. In one embodiment, the polyurethane has a weight average molecular weight of about 25,000 to 100,000, or even higher. Suitable acrylic resins include ethylene unsaturated monomers (vinyl and acrylic) prepared through emulsion polymerization. Suitable polyester resins include polyfunctional acids, polyhydric alcohols and monocarboxylic acids. Other suitable resins include hybrids or mixtures of any of these resins, (i.e., acrylic/polyurethane or acrylic/polyester).

In addition to the above-noted resins, the colored base coating compositions may optionally include other ingredients such as cross-linkers, pigments, tints, colorants, metallic flakes, mica flakes, fillers, extenders, UV absorbers, light stabilizers, plasticizers, surfactants and wetting agents in a total amount of up to 80 weight percent based on the total weight percent of the base coating composition to be applied to the microporous sheet.

Suitable curing agents or cross-linkers include carbodiimides, melamines, formaldehydes and isocyanates. Water-based carbodiimides and isocyanates may be particularly suitable in some applications because they do not add significant amounts of organic solvents into the base coating compositions. When a cross-linker is used, it is generally present in an amount of up to about 50 weight percent, based on the total solid weight of the cured base coating.

The cross-linkers may be activated upon application of the base coating composition to the microporous sheet. Alternatively, the cross-linkers may be activated during subsequent molding operations, such as compression molding or injection molding, where the elevated temperatures experienced during the molding operations are used to activate the cross-linkers. In this case, the cross-linkers may be partially activated upon application to the substrate, and fully cross-linked during the subsequent molding operation. Some cross-linkers that may be suitable for the base coating resins are described in the U.S. Pat. No. 5,939,491. Combinations of cross-linkers can be used.

Suitable pigments that may be used in the colored base coatings include standard inorganic and organic pigments, such as those found in conventional paints. For example, various colored pigments are listed in the Dry Color Manufacturers Association (DCMA) classifications. Suitable tints include pigments dispersed in water-based or water miscible carriers. Some commercially available water-based tints include Aqua-Chem 896 from Degussa, and Charisma Colorants and Maxitoner Industrial Colorants from Accurate Dispersions division of Eastman Chemical. The amount of pigment, tint and/or colorant may be selected depending upon the particular application, and may generally be present in an amount of up to 80 weight percent, based on the solid weight of the cured colored base coating.

Color effect compositions may be used in any of the coating layers according to the present invention. Effect pigments are one type of color effect compositions, any effect pigment known in the art can be used. Non-pigment color effect compositions can include those that comprise radiation diffractive materials in particulate form that, when assembled in an array, act as colorants. “Radiation diffractive particles in an ordered array” refers to an ordered three-dimensional periodic array of particles held in a matrix wherein the difference in refractive index between the matrix and the particles is at least about 0.01, such as at least about 0.05, or at least about 0.1. The radiation diffractive particles in an ordered array reflect visible light according to Bragg's law to yield a goniochromatic effect. Examples of such effect compositions are disclosed in published U.S. patent application Ser. No. 2003/0125416, which is incorporated herein by reference.

In accordance with the present invention, colored base coatings and clear coatings as described above are applied to microporous sheets. The layer applied directly on the microporous sheet is typically water based. For example, if the colored base coating is applied directly to the microporous sheet, it may be water based. Alternatively, an additional water based layer may be applied on the microporous sheet, followed by application of a water based or non-water based colored base coating.

As used herein, the term “microporous sheet” means a sheet comprising a polymer matrix, an interconnecting network of pores and, optionally, filler particles. The matrix of the microporous sheet may comprise substantially water-insoluble thermoplastic organic polymer. Many kinds of such polymers are suitable for use as the matrix. In general, any substantially water-insoluble thermoplastic organic polymer that can be extruded, calendered, pressed or rolled into film, sheet, strip or web may be used. The polymer may be a single polymer or it may be a mixture of polymers. The polymers may be homopolymers, copolymers, random copolymers, block copolymers, graft copolymers, atactic polymers, isotactic polymers, syndiotactic polymers, linear polymers or branched polymers. When mixtures of polymers are used, the mixture may be homogeneous or it may comprise two or more polymeric phases.

Examples of classes of suitable substantially water-insoluble thermoplastic organic polymers of the microporous sheets include the thermoplastic polyolefins, poly(halo-substituted olefins), polyesters, polyamides, polyurethanes, polyureas, poly(vinyl halides), poly(vinylidene halides), polystyrenes, poly(vinyl esters), polycarbonates, polyethers, polysulfides, polyimides, polysilanes, polysiloxanes, polycaprolactones, polyacrylates, and polymethacrylates. Hybrid classes, for example, thermoplastic poly(urethane-ureas), poly(ester-amides), poly(silane-siloxanes), and poly(ether-esters) are within contemplation. Examples of specific substantially water-insoluble thermoplastic organic polymers include thermoplastic high density polyethylene, low density polyethylene, ultrahigh molecular weight polyethylene, polypropylene (atactic, isotactic, or syndiotactic), poly(vinyl chloride), polytetrafluoroethylene, copolymers of ethylene and acrylic acid, copolymers of ethylene and methacrylic acid, poly(vinylidene chloride), copolymers of vinylidene chloride and vinyl acetate, copolymers of vinylidene chloride and vinyl chloride, copolymers of ethylene and propylene, copolymers of ethylene and butene, poly(vinyl acetate), polystyrene, poly(omega-aminoundecanoic acid) poly(hexamethylene adipamide), poly(epsilon-caprolactam), and poly(methyl methacrylate).

The finely divided, substantially water-insoluble particulate filler of the microporous sheets of the present invention may comprise siliceous and/or non-siliceous particles. The filler particles typically comprise at least 30 or 40 weight percent of the microporous material up to about 70 or 80 weight percent. In one embodiment, the filler particles are the predominant component of the sheet in comparison with the polymer matrix on a weight percent basis. Thus, the filler particles may comprise greater than 50 weight percent of the combined total of the polymer matrix and filler particles. For example, the filler particles may comprise greater than 60 weight percent.

A preferred particulate filler is finely divided substantially water-insoluble siliceous particles. Examples of suitable siliceous particles include particles of silica, mica, montmorillonite, kaolinite, asbestos, talc, diatomaceous earth, vermiculite, natural and synthetic zeolites, cement, calcium silicate, aluminum silicate, sodium aluminum silicate, aluminum polysilicate, alumina silica gels, and glass particles. Of the silicas, precipitated silica, silica gel or fumed silica may be particularly suitable.

Examples of non-siliceous filler particles include particles of titanium oxide, zinc oxide, antimony oxide, zirconia, magnesia, alumina, zinc sulfide, barium sulfate, strontium sulfate, calcium carbonate, magnesium carbonate, magnesium hydroxide, and finely divided substantially water-insoluble flame retardant filler particles such as particles of ethylenebis(tetra-bromophthalimide), octabromodiphenyl oxide, decabromodiphenyl oxide, and ethylenebisdibromonorbomane dicarboximide.

The filler particles typically have an average particle size of less than 40 micrometers. In the case of precipitated silica, the average ultimate particle size (irrespective of whether or not the ultimate particles are agglomerated) may be less than 0.1 micrometer.

Minor amounts, usually less than 5 percent by weight, of other materials used in processing such as lubricant, processing plasticizer, organic extraction liquid, water and the like may optionally also be present. Additional materials introduced for particular purposes may optionally be present in the microporous material in-small amounts, usually less than 15 percent by weight. Examples of such materials include antioxidants, ultraviolet light absorbers, reinforcing fibers such as chopped glass fiber strand and the like.

The microporous sheets also comprise a network of interconnecting pores that communicate substantially throughout the material. On a coating-free basis, the pores typically constitute from 30 to 95 volume percent of the microporous material. For example, the pores may constitute from 60 to 75 percent by volume of the microporous material. On a coating-free basis, the volume average diameter of the pores may be at least 0.02 micrometers, typically at least 0.04 micrometers. The volume average diameter of the pores is also typically less than 0.5 micrometer.

Some examples of microporous sheets are disclosed in U.S. Pat. Nos. 4,833,172; 4,861,644; and 6,114,023, which are incorporated herein by reference. Commercially available microporous printing sheets are sold under the designation Teslin® by PPG Industries, Inc.

FIG. 2 illustrates a coated microporous sheet 15 comprising a microporous sheet 10 coated with a colored base coating 20, an intermediate layer 25, and a clear coating 30 in accordance with another embodiment of the present invention. The intermediate layer 25 may comprise a visual effects coating, a protective coating (such as UV curable urethane acrylate, light stabilizers and/or antioxidants), or any other desired coating, which may be applied on the colored base coating 20 by suitable conventional techniques. A visual effects coating is generally a coating that exhibits a change in perceived appearance, such as hue, chroma, and/or lightness, with viewing angle, lighting conditions or other external stimulus. A protective coating is a coating that affords some level of protection, such as from mar, scratch, light, chemicals and the like. Alternatively, desirable visual effects and/or protection can be included in the colored basecoat and/or the topcoat.

FIG. 3 schematically illustrates the application of the clear coating 30 on the colored base coating 20 using a release sheet 40. The clear coating 30 composition may be applied on the release sheet 40 in liquid form by spraying, slot coating, roll coating, curtain coating, screen printing and/or rod coating.

As shown in FIG. 3, nip rollers 41 and 42 are used to press the exposed face of the clear coating 30 against the colored base coating 20 and microporous sheet 10. Pressure applied on the sheets as they pass through the nip rollers 41 and 42 helps adhere the clear coating composition 30 to the base coating 20. The pressing operation may-be carried out at room temperature. Alternatively, the clear coating composition 30 may be adhered to the base coating at an elevated temperature. After passing through the nip rollers 41 and 42, the clear coating 30 may be at least partially cured by UV radiation that passes through the release sheet 40. UV cure times of from about 0.1 second to about 1 minute are typically satisfactory. After the curing stage, the release sheet 40 may be peeled or otherwise removed from the clear coating 30.

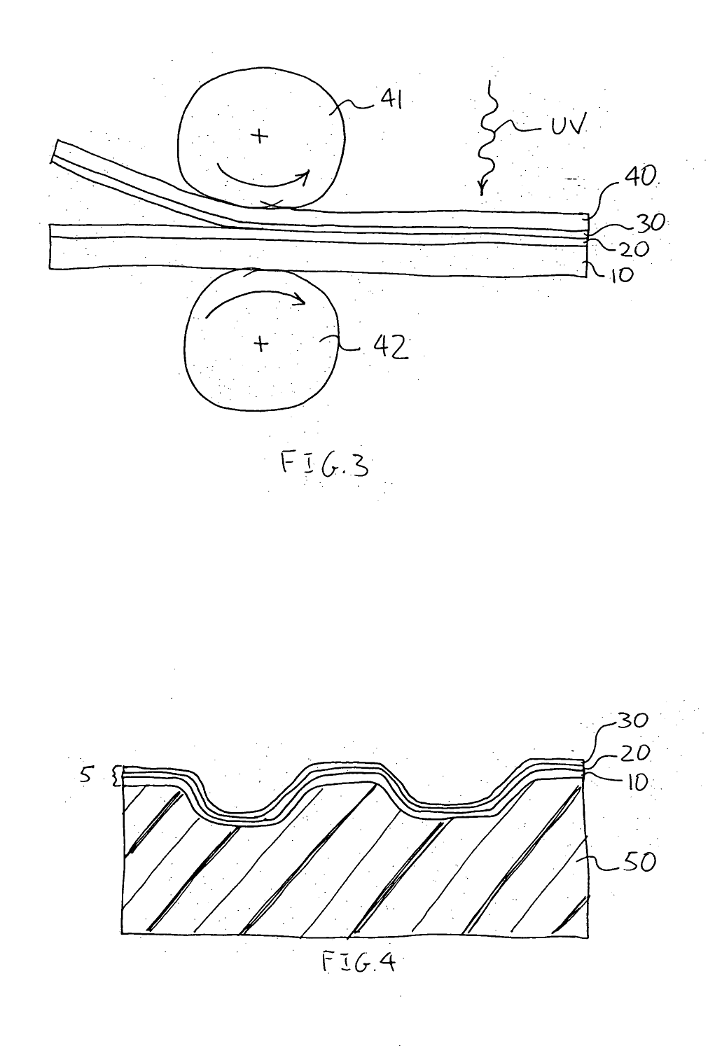

In accordance with an embodiment of the present invention, the coated microporous sheet 5 may be laminated on a substrate material. FIG. 4 illustrates a substrate 50 made of plastic, metal, wood or the like covered by the coated microporous sheet 5. As shown in FIG. 4, the coated microporous sheet 5 may include deformation regions in which the sheet undergoes substantial elongation and/or compression. Lamination of the coated microporous sheet 5 on the substrate 50 may be achieved by any suitable technique. For example, the substrate 50 and coated sheet 5 may be positioned between press molds and deformed to form a contoured coating layer on a contoured substrate. The press mold(s) and/or substrate may be heated to a suitable temperature, such as from about 100 to about 200° C., depending on the particular substrate material being molded. Heat generated by the press mold(s) may be used to facilitate cross-linking of the base coating and/or clear coating. Standard molding pressures may be used.

Alternatively, standard injection molding techniques may be used to produce the laminated product, wherein the coated microporous sheet is placed with its coated side against at least one inside face of a mold cavity, followed by injection of any suitable thermal plastic such as polypropylene, nylon, PBT or PET. Such thermal plastics may be reinforced with glass or other reinforcements known to those skilled in the art. The clear coating may be applied before, during or after the molding process. Furthermore, the colored base coat may be applied before, during or after the molding operation.

In one embodiment, the coated microporous sheet 5 is laminated on the substrate 50 during the compression molding process without the use of adhesives. Alternatively, an adhesion promoter may be used between the coated microporous sheet 5 and the substrate 50. In this case, a layer of adhesion promoter may be pre-applied to the microporous sheet on the opposite side from the coating, or onto the substrate itself. This may be particularly useful for wood-based substrates. Standard adhesion promoters, such as urea-formaldehyde or melamine-urea-formaldehyde adhesion promoters, can be used.

During molding processes, high-draw deformation regions may be created in the colored base coating 20 and clear coating 30. In some high-draw molding operations, elongation at break of 25, 50, 75 or 100 percent, or higher, may be experienced. Elongation at break can be measured using an Instron, such as Instron Mini 44 Unit equipped with a 50N load cell. The ability of the coated microporous sheets of the present invention to withstand substantial elongation allows for their use in applications where the sheets undergo deformation, such as high-draw, in-mold processes.

The following examples are intended to illustrate various aspects of the present invention and are not intended to limit the disclosure or claims of the invention.

### EXAMPLE 1

This example illustrates the preparation of relatively high molecular weight polyurethane using a lower molecular weight polyether diol. A reaction vessel equipped with a stirrer, thermocouple, condenser and nitrogen inlet was charged with 1447.3 grams (g) polytetramethylene ether glycol having a molecular weight of about 1,000 sold under the designation TERATHANE 1000 and 145.4 g dimethylolpropionic acid and heated to 60° C. 965.3 g isophorone diisocyanate was added over 13 minutes followed by 637.5 g methyl ethyl ketone and 4.34 g dibutyltin dilaurate. The reaction exothermed to 72° C. The reaction temperature was raised to 80° C. and the contents were stirred until the isocyanate equivalent weight was 923.5. Then 114.0 g dimethylolpropionic acid was added to the reaction flask. The contents were stirred until the isocyanate equivalent weight was 1430.2.

1512.2 grams of above prepolymer 75° C. was added over 16 minutes to a solution of 2201.9 g deionized water, 58 g adipic acid dihydrazide and 76.2 g dimethyl ethanol amine stirring at 25° C. and at 515 rpm in a cylindrical gallon reaction flask equipped with baffles, double pitched bladed stirrer, thermocouple and condenser. The dispersion temperature after this addition was 40° C. The reaction contents were stirred until no evidence of isocyanate was observed by FTIR. This dispersion was transferred to a flask equipped with a stirrer, thermocouple, condenser and a receiver. The dispersion was heated to 50° C. and methyl ethyl ketone and water were removed by vacuum distillation.

The final polyurethane dispersion had a solids content of 37.48 weight percent (measured for one hour at 110° C.), a Brookfield viscosity of 1450 centipoise using a #3 spindle at 60 rpm, an acid content of 0.240 meq acid/g, a base content of 0.247 meq base/g, a residual methyl ethyl ketone content of 1.16 weight percent and a weight average molecular weight of 77274 in DMF.

Water-based colored coating compositions, using the resin produced as described in Example 1, are described in Table 1.

TABLE 1
Colored Coating Compositions

| | Sample 1-A | Sample 1-B | Sample 1-C |
|---|---|---|---|
| Ingredient | (Blue) | (Black) | (Green) |
| Polyurethane | 59.39 | 72.34 | 59.39 |
| Dispersion From | | | |
| Example #1 | | | |
| OneSource 9292- | 17.15 | — | 0.90 |
| T1467 (White) | | | |
| OneSource 9292- | 0.73 | — | 3.63 |
| G9463 (Green) | | | |
| OneSource 9292- | 7.13 | — | — |
| L8843 (Blue) | | | |
| OneSource 9292- | — | 6.00 | — |
| B3546 (Black) | | | |
| OneSource 9292-S893 | — | — | 12.20 |
| (Yellow Oxide) | | | |
| OneSource 9292-Y114 | — | — | 8.27 |
| (Yellow) | | | |
| Carbodilite ® V02L2 | 15.60 | 21.66 | 15.61 |
| Total | 100.00 | 100.00 | 100.00 |

Notes:
OneSource 9292-T1467 Tint, OneSource 9292-G9463 Tint, OneSource 9292-L8843 Tint, OneSource 9292-S893 Tint, OneSource 9292-Y114, and OneSource 9292-B3546 Tint are commercially available from PPG Industries, Inc.
Carbodilite ® V02L2 is a product of Nisshinbo Industries, Inc.

Samples 1-A and 1-B were applied to rolls of microporous sheet using a continuous process. Rolls of Teslin® SP700, or SP1000 sheets were coated using Frontier Industrial Technology (Towanda, Pa.) laboratory-scale slot-die coater. The resultant coated microporous films were thermal cured for approximately 1 min at 250° F.

### EXAMPLE 2

Several UV curable clear coating compositions were prepared, as described in Table 2.

TABLE 2
UV Curable Clear Coating Compositions

| | Sample | Sample | Sample | Sample | |
|---|---|---|---|---|---|
| Ingredient | 2-A | 2-B | 2-C | 2-D | Sample 2-E |
| CN-981B88¹ | 20.68 | — | — | — | — |
| CN-966J75² | 20.68 | — | — | — | — |
| CN-990³ | 10.34 | — | — | — | — |
| Aliphatic polyether | — | — | — | — | 28.18 |
| urethane acrylate | | | | | |
| Aliphatic polyether | — | — | — | 45.72 | — |
| urethane acrylate | | | | | |
| Aliphatic polyether | — | 41.75 | — | — | 28.18 |
| urethane acrylate | | | | | |
| Isobornyl acrylate | 20.68 | 19.58 | — | 17.14 | 26.43 |
| from UCB | | | | | |
| Chemicals | | | | | |
| Ethylhexyl acrylate, | — | 10.59 | — | 9.53 | 14.30 |
| 2-from Celanese | | | | | |
| S-379N⁴ | — | 0.65 | — | — | — |
| SR-9020⁵ | | | 42.10 | — | — |
| SR-295⁶ | | | 8.07 | — | — |
| SR-494⁷ | | | 7.50 | — | — |
| Darocur 4265⁸ | 2.17 | 2.16 | 1.73 | 2.17 | 2.91 |
| n-Butyl acetate | 25.45 | 25.27 | — | 25.44 | — |
| Ethanol | — | — | 40.60 | — | — |
| Total | 100.00 | 100.00 | 100.00 | 100.00 | 100.00 |

¹Aliphatic polyester/polyether based urethane diacrylate oligomer blended with 12% hexanediol diacrylate monomer from Sartomer.
²Aliphatic polyester based urethane diacrylate oligomer blended with 25% isobornyl acrylate from Sartomer.
³Aliphatic urethane acrylate oligomer containing bound silicone for improved slip properties from Sartomer.
⁴S-379N wax from Shamrock.
⁵Propoxylated (3) glyceryl triacylate from Sartomer.
⁶Pentaerythritol tetraacrylate from Sartomer.
⁷Ethoxylated (4) pentaerythritol tetraacrylate from Sartomer.
⁸Photo initiator from Ciba-Geigy Corp.

The clear coating compositions were applied to a high-grade PET film (Quest Film, Inc.) using a slot-die coater to a thickness of 1.2 mil. The clear coating was applied to color-coated microporous sheets using the following procedure. First, the UV curable clear coating composition was applied to the PET film using the slot-die coater. The coated PET and color-coated Teslin® microporous film produced in Example 1 were then fed through a nip apparatus located within the slot coater unit, producing a multi-layer laminate. The nipped laminate was then exposed to UV light source (a single 1600 watt mercury lamp; parabolic reflector; ruminating 6 inches; line speed of 15 feet per minute) to cure the liquid clear coat. Subsequently, the PET film was removed, exposing a high quality colored basecoat/clear coat finish.

The appearance and physical properties of the coated (basecoat/clear coat) Teslin® microporous film were quantified using the following tests. Specular gloss was measured at 20° with a Byk-Gardner micro TRI-gloss #4520, where higher numbers indicate better performance. Distinction of image (DOI) of coating systems was determined using a C-Box (Glow box Model GB11-8 with image of Landolt rings from Instruments for Research and Industries (I²R) of Cheltenham, Pa.). Various size “C's” are projected onto the coated substrate. DOI is quantified by determining the smallest “C's” that are not distorted, again, higher numbers indicating superior appearance.

The degree of coating cure was determined by testing the solvent resistance using acetone double rubs. The higher the number of double rubs the better the cure, with no damage to the coating. An index finger holding a double thickness of cheesecloth saturated with acetone is held at a 45-degree angle to the coating surface. The rub is made with moderate pressure at a rate of 1 double rub per second. The test is typically run to failure of the coating.

Mechanical properties of the coated microporous sheets were evaluated using an Instron Mini 44 unit with a crosshead speed of 25 mm/min. Testing was performed on samples having lengths of 76.2 mm and widths of 6.4 mm, with a test gauge length of 25.4 mm. The film orientation of “machine” or “transverse” listed in the table corresponds to the orientation of the microporous sheet. The term “elongation” means percentage elongation at break. The higher number indicates more elongation.

Results listed in Table 1.

TABLE 3
Coated Microporous Sheet Physical Properties

| Sam- | Coating | Coating | | C- | Acetone | Film | |
|---|---|---|---|---|---|---|---|
| ple | Theory | DFT | 20° | Box | Double | Orienta- | Elonga- |
| ID | Solids | (mil) | Gloss | DOI | Rubs | tion | tion |
| 2-A | 74% | 1.2 | 81 | 50 | >50 | Machine | 102 ± 4 |
| | | | | | | Transverse | 108 ± 1 |
| 2-B | 74% | 1.2 | 82 | 60 | >50 | Machine | 74 ± 1 |
| | | | | | | Transverse | 84 ± 3 |
| 2-C | 59% | 1.2 | 82 | 55 | >50 | Machine | 10 |
| | | | | | | Transverse | 10 |
| 2-D | 74% | 1.2 | 80 | 50 | 20 | Machine | 204 |
| | | | | | | Transverse | 224 |
| 2-E | 100% | 1.2 | 80 | 80 | >50 | Machine | 94 ± 8 |
| | | | | | | Transverse | 102 ± 14 |

### EXAMPLE 3

Special effect films are produced using a three-layer system. Teslin® SP700 microporous film is first coated with a black base coat having a composition corresponding to Sample 1-B in Table 1 and cured. A layer of self-assembling latex particles comprising polystyrene and divinylbenzene dispersed in water, as disclosed in published U.S. patent application Ser. No.2003/0125416, is then applied to the basecoat at a thickness of about 2.5 microns. A clear coat layer having a composition corresponding to Sample 2-A in Table 2 is then applied to the coated microporous sheet in a similar manner as described in Example 2. The resulting composite film has an aqua to blue to purple color shift, depending upon the angle of observation. The composite film also possesses excellent color travel, as well as high gloss and DOI.

### EXAMPLE 4

A 100% solids UV curable clear coating composition was formulated as described in Table 4.

TABLE 4

| Ingredient | Sample 3-A |
|---|---|
| Aliphatic polyether urethane acrylate | 28.18 |
| Aliphatic polyether urethane acrylate | 28.18 |
| Isobornyl acrylate from UCB Chemicals | 26.44 |
| Ethylhexyl acrylate, 2-from Celanese | 14.29 |
| Darocur 4265¹ | 2.91 |
| Total | 100.00 |

¹Photo-initiator from Ciba-Geigy Corp.

Clear coat Sample 3-A was applied to color-coated microporous film from Example 1 (Teslin® SP-1000/water-based basecoat), using an 8-path (square) Wet Film Applicator, # 14 available from Paul N. Gardner Company, Inc., Florida.

Three different application procedures were used: clear coat drawdown over PET and laminated to a sheet of coated Teslin(® (from Example 1); clear coat drawdown over coated Teslin® and laminated to an uncoated sheet of PET; and clear coat drawdown directly to a sheet of coated Teslin® (with no PET). Samples were cured using standard mercury arc lamps (200 Watts/in.) in air using an energy density of 370 mj/cm².

PET film, if used as cover sheet, was removed after-the cure process, exposing a coated microporous film. Appearance was quantified as described previously in Example 2. Spectral gloss and DOI of the coated microporous films, as shown below in Table 5, were identical, regardless of the application method used.

TABLE 5

| | | Coating | | |
|---|---|---|---|---|
| Atmosphere | | DFT | 20° | C-Box |
| in UV unit | Application Method | (mil) | Gloss | DOI |
| Air | Drawdown on PET sheet, | 0.8 | 80 | 80 |
| | and laminate to a coated | | | |
| | Teslin ® sheet from Example 1. | | | |
| Air | Drawdown on coated | 0.8 | 81 | 80 |
| | Teslin ® sheet from | | | |
| | Example 1 and laminate to | | | |
| | a PET sheet. | | | |
| Air | Drawdown on | 0.8 | 82 | 80 |
| | Teslin ® sheet, with no | | | |
| | PET sheet. | | | |

### EXAMPLE 5

In this example, a clear coating composition with high elasticity/moldability is produced from the resin binder system previously described in Example 1, without the addition of a pigment. Having both layers thermally curable enables the same equipment (dryers) to be used to cure both coatings. This can be accomplished by first producing a monocoat and then passing the coated sheet through the coater a second time to apply and cure the second coating on top of the first. Alternatively, the basecoat and clear coat can be applied wet-on-wet and cured in a single pass through the dryer. This could be accomplished for example with a slot-die coater with two slots or a cascade coater.

In this example, color-coated Teslin® microporous film from Example 1 was coated with a thermally curable clear coating composition, to produce a basecoat/clear coat film with mechanical properties similar to those of the coated films in Example 1. To impart exterior durability UV absorbers and HALS were added. Additionally, various additives known in the art for rheology control, flow, wetting and flattening, can also be added to tailor the product for specific applications. The thermally curable clear coating compositions are listed in Table 6 in terms of weight percentages.

TABLE 6
Composition of Thermally Curable Clear Coating Compositions

| Ingredient | Sample 4-A | Sample 4-B |
|---|---|---|
| Polyurethane Dispersion | 80.0 | 78.5 |
| From Example #1 | | |
| Carbodilite ® V02-L2 | 20.0 | 19.6 |
| Tinuvin ® 1130 (UV | — | 1.13 |
| absorber) | | |
| Tinuvin ® 292 (HALS) | — | 0.379 |
| Dowanol DPM | — | 0.379 |
| Total | 100 | 100 |

Notes:
Carbodilite ® V02L2 is a product of Nisshinbo Industries, Inc.
Tinuvin ® is a product of Ciba Specialty Chemicals.

### EXAMPLE 6

Coated Teslin® microporous films, having a thermal-cure colored coating (1-A) and a UV cure clear coating (2-B) were successfully used to decorate a glass fiber reinforced polypropylene part. The purpose of the trial was to evaluate the moldability of coated Teslin® microporous film. The process involves the glass-reinforced polypropylene being extruded into a molten glob (˜500° F.) that is transferred into an unheated mold containing a die-cut coated Teslin® insert. The finished part is prepared by compression molding for 1 minute at which time the part is removed from the mold and allowed to finish cooling. The molded article had a smooth surface (bottom) and a textured surface (top). The higher gloss base/clear system was found to maintain the high gloss after the molding when the mold texture was smooth. The film was found to conform to bends in the part without cracking or noticeable color change and were found to be well adhered to the glass filled composite material. Additionally, the basecoat/clear coat films were found to wrap around the edges of the part (90° bend) in the mold with no evidence of cracking.

### EXAMPLE 7

A black base coating corresponding to Sample 1-B of Table 1 is applied to a Teslin® SP700 microporous sheet at a thickness of approximately 0.5 mil and thermally cured. A two-component solvent-based polyurethane clear coat sold under the designation TKU-2000 by PPG Industries is applied by a draw down technique to the coated microporous sheet and cured at 250° F. for about 10 minutes. The resultant clear coated sheet exhibits excellent 20° gloss and DOI properties.

### EXAMPLE 8

A green base coating having a composition corresponding to Sample 1-C in Table 1 is applied to a Teslin® SP700 microporous sheet at a thickness of approximately 0.6 mil and thermally cured. A clear coating composition comprising 15.12 weight percent polyurethane acrylate, 16.2 weight percent butyl acrylate, 3.24 weight percent butyl methacrylate, 1.44 weight percent methyl methacrylate, 0.36 weight percent ethoxylated nonylphenol dispersant, 0.05 weight percent t-butyl hydroperoxide, 0.07 weight percent sodium metabisulfite, 0.001 weight percent ferrous ammoniumsulfate, 52.23 weight percent water, 0.84 weight percent dimethylethanolamine, 8.64 weight percent Propasol B and 1.81 weight percent N-methyl pyrrolidinone (M-Pysol) is applied by a draw down technique to the coated microporous sheet and cured at 250° F. for approximately 1 minute. The resultant clear coated sheet exhibits excellent 20° gloss and DOI properties.

Whereas particular embodiments of this invention have been described above for purposes of illustration, it will be evident to those skilled in the art that numerous variations of the details of the present invention may be made without departing from the invention as defined in the appended claims.

1. A coated microporous sheet comprising:
a microporous sheet;
a colored base coating over at least a portion of the microporous sheet; and
a clear coating over at least a portion of the base coating.

2. The coated microporous sheet of claim 1, wherein the clear coating has a 20 degree gloss of at least 80.

3. The coated microporous sheet of claim 1, wherein the coated microporous sheet has a distinctiveness of image of at least 50.

4. The coated microporous sheet of claim 1, wherein the coated microporous sheet has a distinctiveness of image of at least 70.

5. The coated microporous sheet of claim 1, wherein the coated microporous sheet has an elongation at break of at least 25 percent.

6. The coated microporous sheet of claim 1, wherein the coated microporous sheet has an elongation at break of at least 50 percent.

7. The method coated microporous sheet of claim 1, wherein the clear coating comprises a polyurethane, acrylic, polyether, polyester, polyamide, thermoplastic polyolefin, poly(halo-substituted olefin), polyurea, poly(vinyl halide), poly (vinylidene halide), polystyrene, poly(vinyl ester), polycarbonate, polysulfide, polyimide, polysilane, polysiloxane, polycaprolactone, polyacrylate and/or polymethacrylate.

8. The coated microporous sheet of claim 1, wherein the clear coating comprises a polyurethane.

9. The coated microporous sheet of claim 1, wherein the clear coating is a cured thermoset coating.

10. The coated microporous sheet of claim 1, wherein the clear coating is curable by ultraviolet radiation.

11. The coated microporous sheet of claim 1, wherein the clear coating comprises a UV curable urethane/acrylate.

12. The coated microporous sheet of claim 11, wherein the urethane/acrylate is formed from reacting a polyol, a polyisocyanate and a hydroxyacrylate.

13. The coated microporous sheet of claim 12, wherein the polyol comprises a polyester polyol.

14. The coated microporous sheet of claim 1, wherein the clear coating comprises ultraviolet light absorbers, hindered amine light stabilizers and/or plasticizers.

15. The coated microporous sheet of claim 1, wherein the clear coating has a thickness of from 10 to 50 microns.

16. The coated microporous sheet of claim 1, wherein the colored base coating comprises a substantially solvent-free, water-based resin.

17. The coated microporous sheet of claim 16, wherein the resin of the colored base coating comprises a polyurethane, acrylic polymer or copolymer, polyester, polyether, polycarbonate, polyamide, polymer derived from epoxy-containing polymer and/or vinyl polymer and copolymer.

18. The coated microporous sheet of claim 16, wherein the colored base coating further comprises a pigment, metallic flakes, mica flakes, crosslinkers, fillers, extenders, UV absorbers, light stabilizers, plasticizers, surfactants, thickeners and/or wetting agents.

19. The coated microporous sheet of claim 1, wherein the colored base coating has a thickness of at least 5 microns.

20. The coated microporous sheet of claim 1, further comprising an intermediate layer between the colored base coating and the clear coating.

21. The coated microporous sheet of claim 20, wherein the intermediate layer comprises radiation diffractive particles in an ordered array.

22. The coated microporous sheet of claim 1, wherein the microporous sheet comprises a polymer matrix and at least about 30 weight percent filler particles.

23. The coated microporous sheet of claim 1, wherein the microporous sheet comprises a polymer matrix and at least about 50 weight percent silica filler particles.

24. The coated microporous sheet of claim 1, wherein the microporous sheet comprises a polyethylene matrix and from about 30 to about 95 volume percent pores.

25. A method of coating a microporous sheet comprising:
applying a colored base coating composition on at least a portion of the microporous sheet to form a colored base coating; and
applying a clear coating composition on at least a portion of the colored base coating to form a clear coating.

26. The method of claim 25, wherein the clear coating composition is applied on the colored base coating in liquid form.

27. The method of claim 25, wherein the clear coating composition comprising a polyurethane, acrylic, polyether, polyester, polyamide, thermoplastic polyolefin, poly(halo-substituted olefin), polyurea, poly(vinyl halide), poly (vinylidene halide), polystyrene, poly(vinyl ester), polycarbonate, polysulfide, polyimide, polysilane, polysiloxane, polycaprolactone, polyacrylate and/or polymethacrylate.

28. The method of claim 25, further comprising applying the clear coating composition on a release sheet, prior to the application of the clear coating composition on the colored base coating.

29. The method of claim 28, wherein substantially all of the clear coating composition forms a solid material upon curing.

30. The method of claim 28, wherein the clear coating composition is applied on the release sheet in liquid form by spraying, slot coating, roll coating, curtain coating, screen printing and/or rod coating.

31. The method of claim 30, wherein the liquid clear coating composition comprises less than 5 weight percent organic solvent based on total weight of the clear coating composition.

32. The method of claim 30, wherein the liquid clear coating composition comprises from about 20 to about 80 weight percent water based on total weight of the clear coating composition.

33. The method of claim 28, wherein the clear coating composition comprises from about 10 to about 90 weight percent of a polyurethane/acrylate resin based on total weight of the clear coating composition.

34. The method of claim 33, wherein the liquid clear coating composition further comprises ultraviolet light absorbers, hindered amine light stabilizers and/or plasticizers.

35. The method of claim 28, further comprising:
applying the clear coating composition to the colored base coating; and
applying pressure to the release sheet and the clear coating composition to adhere the clear coating composition to the colored base coating.

36. The method of claim 35, wherein the clear coating is UV curable and further comprising:
exposing the clear coating to ultraviolet radiation through the release sheet to at least partially cure the clear coating; and
removing the release sheet from the at least partially cured clear coating.

37. The method of claim 25, wherein the clear coating has a 20 degree gloss of at least 80 and a distinctiveness of image of at least 50.

38. The method of claim 25, wherein the clear coating has a cured dry film thickness of at least 10 microns.

39. The method of claim 25, wherein the colored base coating composition is applied on the microporous sheet in the form of a liquid comprising less than 20 weight percent organic solvent based on total weight of the colored base coating composition.

40. The method of claim 25, wherein the colored base coating composition is applied on the microporous sheet by spraying, printing, slot coating, roll coating, curtain coating, screen printing and/or rod coating.

41. The method of claim 25, wherein the microporous sheet comprises a polymer matrix and at least about 30 weight percent filler particles.

42. The method of claim 25, wherein the microporous sheet comprises a polyethylene matrix and from about 30 to about 95 volume percent pores.

43. The method of claim 25, further comprising curing the colored base coating prior to the application of the clear coating composition.

44. A laminated article comprising:
a substrate; and
a coated microporous sheet on the substrate, wherein the coated microporous sheet comprises:
a colored base coating over at least a portion of the microporous sheet; and
a clear coating over at least a portion of the colored base coating.

45. The laminated article of claim 44, wherein the clear coating has a 20 degree gloss of at least 80 and a distinctiveness of image of at least 50.

46. The laminated article of claim 44, wherein the substrate comprises a polymer.

47. The laminated article of claim 44, wherein the substrate comprises compression molded or injection molded plastic.

48. The laminated article of claim 44, wherein the coated microporous sheet is adhered directly to the substrate without an adhesive layer.

49. The laminated article of claim 44, wherein at least a portion of the coated microporous sheet has been elongated.

50. The laminated article of claim 49, wherein the elongation is at least 25 percent.

51. A method of making a laminated article, the method comprising:
providing a substrate material; and
adhering a coated microporous sheet on the substrate, wherein the coated microporous sheet comprises:
a colored base coating over at least a portion of the microporous sheet; and
a clear coating over at least a portion of the base coating.

52. The method of claim 51, wherein the clear coating has a 20 degree gloss of at least 80 and a distinctiveness of image of at least 50.

53. The method of claim 51, wherein the coated microporous sheet is adhered directly to the substrate without an adhesive layer.

54. The method of claim 51, wherein at least a portion of the coated microporous sheet is elongated during the adhering step.

55. The method of claim 54, wherein the elongation is at least 25 percent.

56. The method of claim 51, wherein the substrate comprises compression molded or injection molded plastic.

57. The coated microporous sheet of claim 1, wherein at least one of the coating layers comprises radiation diffractive particles in an ordered array.
